(19) United States
(12) Patent Application Publication
(10) Pub. No.: US 2026/0145811 A1
(43) Pub. Date: May 28, 2026

(54) AIRCRAFT CARGO LOADER

(71) Applicant: Oshkosh Corporation, Oshkosh, WI (US)

(72) Inventors: Nick Heemskerk, Oshkosh, WI (US); Faezeh Mesbahi, Oshkosh, WI (US); Michael Church, Oshkosh, WI (US)

(73) Assignee: Oshkosh Corporation, Oshkosh, WI (US)

(21) Appl. No.: 19/371,793

(22) Filed: Oct. 28, 2025

Related U.S. Application Data
(60) Provisional application No. 63/713,857, filed on Oct. 30, 2024.

(51) Int. Cl. B64F 1/32

(52) U.S. Cl. CPC B64F 1/322

(57) ABSTRACT

A system includes a vehicle configured to interface with an aircraft and one or more processing circuits. The vehicle includes a chassis, a plurality of tractive elements coupled to the chassis, a prime mover configured to drive at least one of the plurality of tractive elements to propel the vehicle, and one or more sensors configured to generate sensor data corresponding to the aircraft. The one or more processing circuits are configured to obtain the sensor data from the one or more sensors, determine a classification of the aircraft based on the sensor data, generate recommended controls for the vehicle based on the classification of the aircraft, and provide the recommended controls to an operator of the vehicle.

### CROSS-REFERENCE TO RELATED APPLICATIONS

This application claims the benefit of and priority to U.S. Provisional Application No. 63/713,857, filed Oct. 30, 2024, the entire contents of which are hereby incorporated by reference herein.

### BACKGROUND

Aircraft cargo loaders include various features and systems that facilitate alignment with aircrafts. By way of example, the features and systems may facilitate identification of docking doors of aircraft. However, such features and systems are limited to identifying information associated with the docking doors of the aircraft, thereby limiting an amount of information regarding the aircraft that can be provided to an operator of the aircraft cargo loader.

### SUMMARY

One embodiment relates to a system. The system includes a vehicle configured to interface with an aircraft and one or more processing circuits. The vehicle includes a chassis, a plurality of tractive elements coupled to the chassis, a prime mover configured to drive at least one of the plurality of tractive elements to propel the vehicle, and one or more sensors configured to generate sensor data corresponding to the aircraft. The one or more processing circuits are configured to obtain the sensor data from the one or more sensors, determine a classification of the aircraft based on the sensor data, generate recommended controls for the vehicle based on the classification of the aircraft, and provide the recommended controls to an operator of the vehicle.

Another embodiment relates to a cargo loader vehicle configured to interface with an aircraft. The cargo loader vehicle includes a chassis, a plurality of tractive elements coupled to the chassis, a prime mover configured to drive at least one of the plurality of tractive elements to propel the cargo loader vehicle, a platform assembly configured to interface with the aircraft to receive cargo, a lift coupled between the chassis and the platform assembly, and one or more processing circuits. The platform assembly includes a platform and a flap pivotably coupled to the platform. The flap is pivotable between a raised position and a lowered position. A forward end of the platform has a first width when the flap is in the raised position and a second width when the flap is in the lowered position. The first width is greater than the second width. The lift is configured to raise and lower the platform assembly relative to the chassis. The one or more processing circuits are configured to acquire aircraft data corresponding to the aircraft, determine, based on the aircraft data, a classification of the aircraft, generate, based on the classification of the aircraft, recommended controls for the cargo loader vehicle, and provide the recommended controls to an operator of the cargo loader vehicle. The recommended controls include at least one of operating the lift to position the platform assembly at a height relative to the chassis, placing the flap in the raised position or the lowered position, or operating the prime mover to propel the cargo loader vehicle along a path toward the aircraft.

Yet another embodiment relates to a method for providing recommended controls to an operator of a vehicle. The method includes acquiring, from one or more sensors of the vehicle, sensor data corresponding to an aircraft, determining, based on the sensor data, a classification of the aircraft, generating, based on the classification of the aircraft, recommended controls for the vehicle, and providing the recommended controls to an operator of the vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle including various features described herein, according to an exemplary embodiment.

FIG. 2 is a front view of the vehicle of FIG. 1 having a docking ramp in a first configuration, according to an exemplary embodiment.

FIG. 3 is a front view of the vehicle of FIG. 1 with the docking ramp shown in FIG. 2 in a second configuration, according to an exemplary embodiment.

FIG. 4 is a front view of the vehicle of FIG. 1 with the docking ramp shown in FIG. 2 in a third configuration, according to an exemplary embodiment.

FIG. 5 is a front view of the vehicle of FIG. 1 with the docking ramp shown in FIG. 2 in a fourth configuration, according to an exemplary embodiment.

FIG. 6 is a block diagram of a vehicle system including the vehicle of FIG. 1, according to an exemplary embodiment.

FIG. 7 is a perspective view of a portion of the vehicle of FIG. 1 approaching an aircraft, according to an exemplary embodiment.

FIG. 8 is a top view of an approach path for the vehicle of FIG. 1 to approach a front portion of an aircraft, according to an exemplary embodiment.

FIG. 9 is a top view of an approach path for the vehicle of FIG. 1 to approach a rear portion of an aircraft, according to an exemplary embodiment.

FIG. 10 is a top view of an approach path for the vehicle of FIG. 1 to approach an angled portion of an aircraft, according to an exemplary embodiment.

FIG. 11 is a top view of a warning area and an alert area of the vehicle of FIG. 1, according to an exemplary embodiment.

FIG. 12 is a top view of a warning area and an alert area of the vehicle of FIG. 1 having an extension portion, according to an exemplary embodiment.

FIG. 13 is a top view of left docking position, a center docking position, and a right docking position of the vehicle of FIG. 1 when docking with an aircraft, according to an exemplary embodiment.

FIG. 14 is a front view of the vehicle of FIG. 1 approaching an aircraft, according to an exemplary embodiment.

FIG. 15 is a configuration of a user interface provided to an operator of the vehicle of FIG. 1, according to an exemplary embodiment.

FIG. 16 is another configuration of the user interface provided to the operator of the vehicle of FIG. 1, according to an exemplary embodiment.

FIG. 17 is a flow chart of a process for providing recommended controls to an operator of the vehicle of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

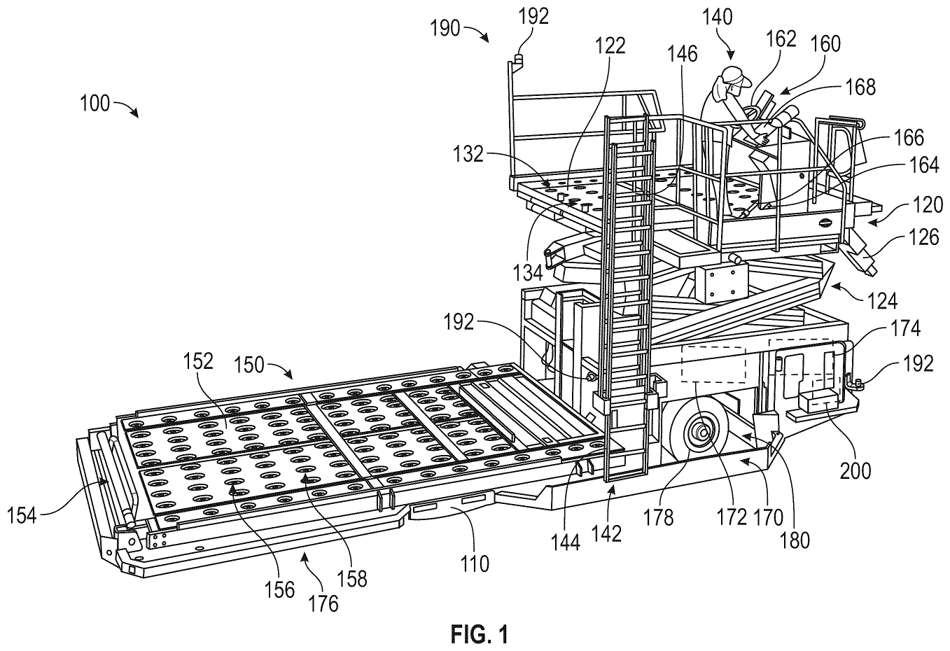

As shown in FIG. 1, a vehicle or machine, shown as vehicle 100, includes a chassis, shown as frame 110; a first platform assembly (e.g., a first body assembly, etc.), shown as forward platform assembly 120, coupled to a forward portion of the frame 110 and having an occupant portion or section, shown as occupant area 140; a second platform assembly (e.g., a second body assembly, etc.), shown as rearward platform assembly 150, coupled to a rearward portion of the frame 110 (e.g., rearward of the forward platform assembly 120, etc.); operator input and output devices, shown as operator controls 160, that are disposed thing the occupant area 140; a drivetrain, shown as driveline 170, coupled to the frame and at least partially disposed under the forward platform assembly 120 and/or the rearward platform assembly 150; a vehicle braking system, shown as braking system 180, coupled to one or more components of the driveline 170 to facilitate selectively braking the one or more components of the driveline 170; one or more first sensors, shown as sensors 190; and a control system, shown as vehicle control system 200, coupled to the operator controls 160, the driveline 170, the braking system 180, and the sensors 190 and configured to facilitate autonomous or semi-autonomous operation of the vehicle 100 or components thereof. In some embodiments, the vehicle 100 includes more or fewer components.

According to an exemplary embodiment, the vehicle 100 is an aircraft cargo loader machine or vehicle (e.g., an aircraft interface vehicle, etc.). In some embodiments, the aircraft interface machine or vehicle is a heavyweight or industrial machine or vehicle such as an aircraft cargo loader, an aircraft catering truck, an aircraft mobile stair vehicle, an aircraft fuel truck, an aircraft water service truck, an aircraft waste removal truck, and/or another type of machine or vehicle configured to interface with aircraft. In operation, the forward platform assembly 120 may align with a door of an aircraft to receive cargo from the aircraft and/or provide cargo to the aircraft.

According to the exemplary embodiment shown in FIGS. 1-5, the forward platform assembly 120 includes a first platform (e.g., first cargo platform, upper cargo platform, etc.), shown as forward platform 122, configured to receive cargo from aircraft and/or provide cargo to aircraft; a first lift (e.g., a first lift device, a first lifting mechanism, etc.), shown as forward scissor lift 124, coupled between the frame 110 and the forward platform 122 and configured to selectively raise and lower the forward platform 122 relative to the frame 110; a first wing (e.g., a left flap, a first width adjusting portion, etc.), shown as first flap 126, pivotably coupled to a forward end of the forward platform 122 and selectively pivotable between a raised position and a lowered position; a second wing (e.g., an outer right flap, a second width adjusting portion, etc.), shown as second flap 128, pivotably coupled to the forward end of the forward platform 122 and selectively pivotable between a raised position and a lowered position; and a third wing (e.g., an inner right flap, a third width adjusting portion, etc.), shown as third flap 130, pivotably coupled to the forward end of the forward platform 122 at a location inward of the second flap 128 and selectively pivotable between a raised position and a lowered position.

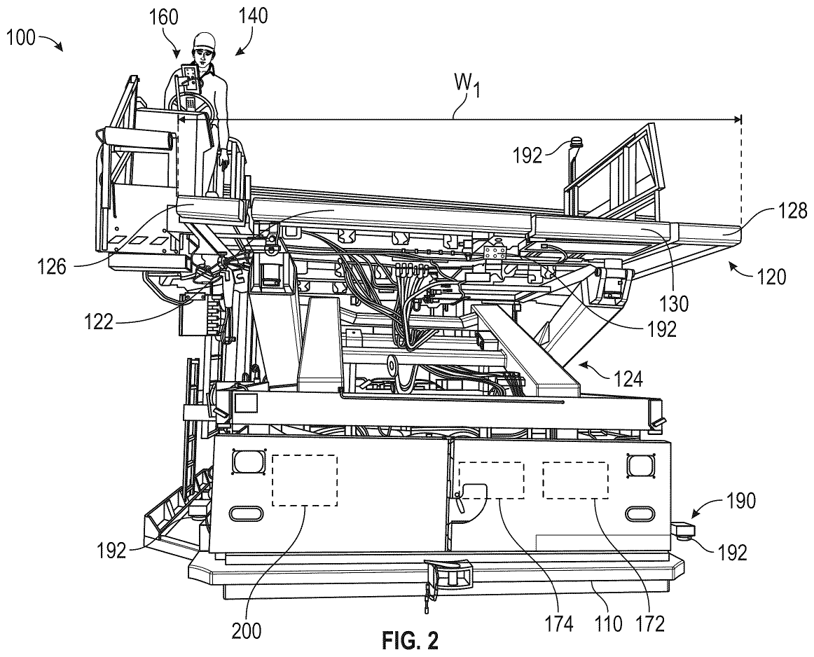

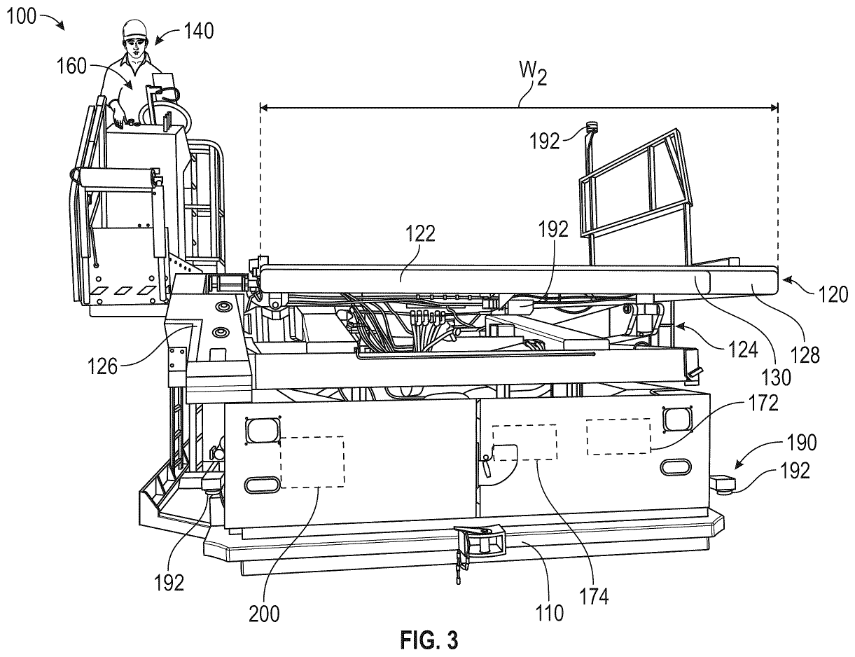

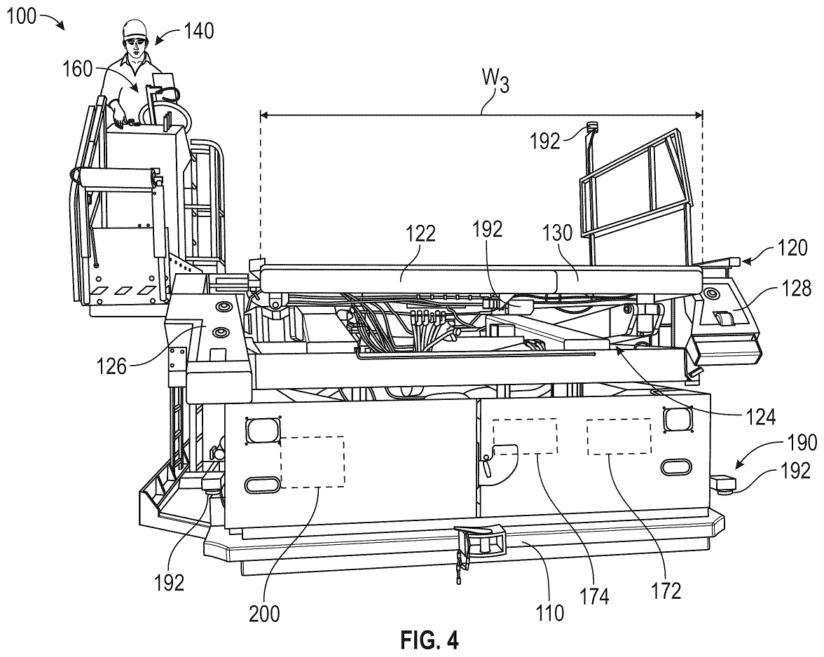

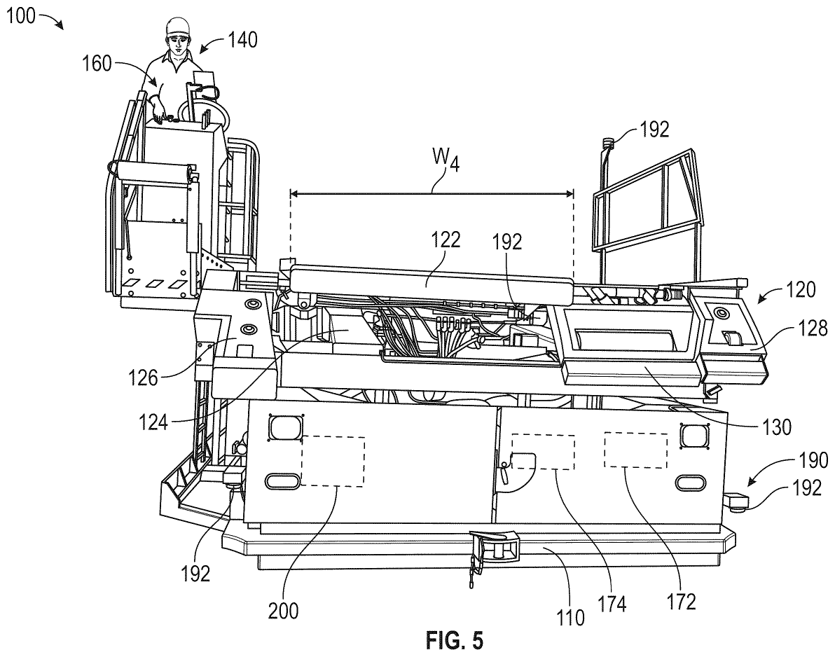

The first flap 126, the second flap 128, and the third flap 130 may be pivoted relative to the forward platform 122 in order to change a width of a front end of the forward platform assembly 120. By way of example, the width of the front end of the forward platform assembly 120 may be changed based on a door opening of the aircraft that the vehicle 100 will be docking with. As shown in FIG. 2, when the first flap 126, the second flap 128, and the third flap 130 are each in the raised position, the front end of the forward platform assembly 120 has a first width W₁. As shown in FIG. 3, when the first flap 126 is in the lowered position and the second flap 128, and the third flap 130 are in the raised position, the front end of the forward platform assembly 120 has a second width W₂ that is less than the first width W₁. As shown in FIG. 4, when the first flap 126 and the second flap 128 are in the lowered position and the third flap 130 is in the raised position, the front end of the forward platform assembly 120 has a third width W₃ that is less than the second width W₂. As shown in FIG. 5, when the first flap 126, the second flap 128, and the third flap 130 are in the lowered position, the front end of the forward platform assembly 120 has a fourth width W₄ that is less than the third width W₃. In some embodiments, when the second flap 128 and the third flap 130 are in the lowered position and the first flap 126 is in the raised position, the front end of the forward platform assembly 120 has a fifth width that is less than the first width W₁ and may be greater than or less than the second width W₂, the third width W₃, or the fourth width W₄. When the first flap 126, the second flap 128, and the third flap 130 are in the raised positions, top surfaces of the first flap 126, the second flap 128, and the third flap 130 may be coplanar (e.g., substantially coplanar, etc.) with a top surface of the forward platform 122.

As shown in FIG. 1, the forward platform assembly 120 includes a first plurality of cargo traction elements (e.g., cargo wheels, etc.), shown as forward cargo wheels 132, aligned with and extending through a first plurality of apertures, shown as forward platform apertures 134, defined by the forward platform 122. The forward cargo wheels 132 extend above the top surface of the forward platform 122 and may be selectively operated to move objects at least partially supported by the forward platform assembly 120 relative to the forward platform 122. By way of example, when a cargo box is at least partially supported by the forward platform assembly 120 (e.g., when unloading the cargo box from an aircraft, when loading the cargo box from an aircraft, etc.), the forward cargo wheels 132 may be operated to move the cargo box forward and backward relative to the forward platform 122. In some embodiments, the forward cargo wheels 132 may be configured as multi-directional wheels (e.g., mecanum wheels, etc.) that may be selectively operated to move objects in a multiple directions relative to the forward platform 122. By way of example, when portions of the forward cargo wheels 132 are rotated in different directions, the cargo box at least partially supported by the forward platform assembly 120 may be moved forward, backward, or sideways to allow for the cargo box to be aligned relative to the aircraft and/or the rearward platform assembly 150.

As shown in FIGS. 1-5, the occupant area 140 is configured as an occupant standing area that does not include a seat. In other embodiments, the occupant area 140 includes a seat. As shown in FIG. 1, the vehicle 100 includes a ladder, shown as ladder assembly 142, coupled to at least one of the frame 110 or the forward platform assembly 120 and configured to allow for an operator to access the occupant area 140. According to the exemplary embodiment shown in FIG. 1, the ladder assembly 142 includes a first ladder portion, shown as lower ladder portion 144, coupled to the frame 110, and a second ladder portion, shown as upper ladder portion 146, coupled to the forward platform 122 of the forward platform assembly 120 and slidably coupled to the lower ladder portion 144 such that the upper ladder portion 146 slides relative to the lower ladder portion 144 when the forward scissor lift 124 raises and lowers the forward platform 122 relative to the frame 110.

As shown in FIG. 1, the rearward platform assembly 150 includes a second platform (e.g., second cargo platform, lower cargo platform, etc.), shown as rearward platform 152, configured to receive cargo from and/or provide cargo to the forward platform 122 of the forward platform assembly 120 and a second lift (e.g., a second lift device, a second lifting mechanism, shown as rearward scissor lift 154, coupled between the frame 110 and the rearward platform 152 and configured to selectively raise and lower the rearward platform 152 relative to the frame 110. In some embodiments, when the rearward platform 152 is in a raised position and the forward platform 122 is in a lowered position, the top surface of the forward platform 122 may align with a top surface of the rearward platform 152 such that objects can be transferred between the forward platform 122 and the rearward platform 152. By way of example, while loading an aircraft, cargo boxes may be transferred from the rearward platform 152 to the forward platform 122 when the top surface of the rearward platform 152 is aligned with the top surface of the forward platform 122 and then the forward platform 122 may be raised by the as forward scissor lift 124 to align with a cargo door of the aircraft to transfer the cargo boxes from the forward platform 122 into the aircraft.

As shown in FIG. 1, the rearward platform assembly 150 includes a second plurality of cargo traction elements, shown as rearward cargo wheels 156, aligned with and extending through a second plurality of apertures, shown as rearward platform apertures 158, defined by the rearward platform 152. The rearward cargo wheels 156 extend above the top surface of the rearward platform 152 and may be selectively operated to move objects at least partially supported by the rearward platform assembly 150. By way of example, when moving a cargo box from the rearward platform assembly 150 to the forward platform assembly 120, the forward scissor lift 124 may raise and/or lower the forward platform 122 and/or the rearward scissor lift 154 may raise and/or lower the rearward platform 152 to align the top surface of the forward platform 122 with the top surface of the rearward platform 152. Once the top surface of the forward platform 122 is aligned with the top surface of the rearward platform 152, the rearward cargo wheels 156 and the forward cargo wheels 132 may be operated to move the cargo box forward in a direction from the rearward platform 152 towards the forward platform 122. In some embodiments, the rearward cargo wheels 156 may be configured as multi-directional wheels (e.g., mecanum wheels, etc.) that may be selectively operated to move objects in a multiple directions relative to the rearward platform 152.

According to an exemplary embodiment, the operator controls 160 are configured to provide an operator with the ability to control one or more functions of and/or provide commands to the vehicle 100 and the components thereof (e.g., turn on, turn off, drive, brake, engage various operating modes, raise/lower a platform, etc.). As shown in FIG. 1, the operator controls 160 include a steering interface (e.g., a steering wheel, joystick(s), etc.), shown as steering wheel 162, an accelerator interface (e.g., a pedal, a throttle, etc.), shown as accelerator 164, a braking interface (e.g., a pedal), shown as brake 166, and one or more additional interfaces, shown as operator interface 168. The operator interface 168 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 170 is configured to propel the vehicle 100. As shown in FIGS. 1-5, the driveline 170 includes a primary driver, shown as prime mover 172, an energy storage device, shown as energy storage 174, a first tractive assembly (e.g., axles, wheels, tracks, differentials, etc.), shown as rear tractive assembly 176, and a second tractive assembly (e.g., axles, wheels, tracks, differentials, etc.), shown as front tractive assembly 178. In some embodiments, the driveline 170 is a conventional driveline whereby the prime mover 172 is an internal combustion engine and the energy storage 174 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 170 is an electric driveline whereby the prime mover 172 is an electric motor and the energy storage 174 is a battery system. In some embodiments, the driveline 170 is a fuel cell electric driveline whereby the prime mover 172 is an electric motor and the energy storage 174 is a fuel cell (e.g., that stores hydrogen, that produces electricity from the hydrogen, etc.). In some embodiments, the driveline 170 is a hybrid driveline whereby (i) the prime mover 172 includes an internal combustion engine and an electric motor/generator and (ii) the energy storage 174 includes a fuel tank and/or a battery system. According to the exemplary embodiment shown in FIG. 1, the rear tractive assembly 176 includes rear tractive elements and the front tractive assembly 178 includes front tractive elements that are configured as wheels. In some embodiments, the rear tractive elements and/or the front tractive elements are configured as tracks.

According to an exemplary embodiment, the prime mover 172 is configured to provide power to drive the rear tractive assembly 176 and/or the front tractive assembly 178 (e.g., to provide front-wheel drive, rear-wheel drive, four-wheel drive, and/or all-wheel drive operations). In some embodiments, the driveline 170 includes a transmission device (e.g., a gearbox, a continuous variable transmission (“CVT”), etc.) positioned between (a) the prime mover 172 and (b) the rear tractive assembly 176 and/or the front tractive assembly 178. The rear tractive assembly 176 and/or the front tractive assembly 178 may include a drive shaft, a differential, and/or an axle. In some embodiments, the rear tractive assembly 176 and/or the front tractive assembly 178 include two axles or a tandem axle arrangement. In some embodiments, the rear tractive assembly 176 and/or the front tractive assembly 178 are steerable (e.g., using the steering wheel 162). In some embodiments, both the rear tractive assembly 176 and the front tractive assembly 178 are fixed and not steerable (e.g., employ skid steer operations).

In some embodiments, the driveline 170 includes a plurality of prime movers 172. By way of example, the driveline 170 may include a first prime mover 172 that drives the rear tractive assembly 176 and a second prime mover 172 that drives the front tractive assembly 178. By way of another example, the driveline 170 may include a first prime mover 172 that drives a first one of the front tractive assembly 178, a second prime mover 172 that drives a second one of the front tractive elements, a third prime mover 172 that drives a first one of the rear tractive elements, and/or a fourth prime mover that drives a second one of the rear tractive elements. By way of still another example, the driveline 170 may include a first prime mover 172 that drives the front tractive assembly 178, a second prime mover 172 that drives a first one of the rear tractive elements, and a third prime mover 172 that drives a second one of the rear tractive elements. By way of yet another example, the driveline 170 may include a first prime mover 172 that drives the rear tractive assembly 176, a second prime mover 172 that drives a first one of the front tractive elements, and a third prime mover 172 that drives a second one of the front tractive elements.

According to an exemplary embodiment, the braking system 180 includes one or more braking components (e.g., disc brakes, drum brakes, in-board brakes, axle brakes, etc.) positioned to facilitate selectively braking one or more components of the driveline 170. In some embodiments, the one or more braking components include (i) one or more front braking components positioned to facilitate braking one or more components of the front tractive assembly 178 (e.g., the front axle, the front tractive elements, etc.) and (ii) one or more rear braking components positioned to facilitate braking one or more components of the rear tractive assembly 176 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 190 may include various sensors positioned about the vehicle 100 to acquire vehicle information or vehicle data regarding operation of the vehicle 100 and/or the location thereof. By way of example, the sensors 190 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 100 and/or the location thereof. As shown in FIGS. 1-5, the sensors 190 includes a plurality of range finding sensors (e.g., LiDAR sensors, radar sensors, sonar sensors, etc.), shown as range sensors 192, configured to generate sensor data associated with surroundings of the vehicle 100. By way of example, the range sensors 192 may be LiDAR sensors configured to generate sensor data associated with the surroundings of the vehicle 100 by emitting lasers and measuring reflections of the lasers that return to the range sensors 192. In other embodiments, the sensors 190 includes a single range sensor 192.

As shown in FIGS. 1-5, a first plurality of the range sensors 192 are coupled to the forward platform 122 of the forward platform assembly 120 and a second plurality of the range sensors 192 are coupled to the frame 110. The first plurality of the range sensors 192 coupled to the forward platform 122 may be configured to generate sensor data associated with a first portion of the surroundings of the vehicle 100 positioned a first range of heights above a ground supporting the vehicle 100 and the second plurality of the range sensors 192 coupled to the frame 110 may be configured to generate sensor data associated with a second portion of the surrounds of the vehicle 100 positioned a second range of heights above the ground. The first range of heights may be at least partially higher than the second range of heights. As the forward scissor lift 124 raises and lowers the forward platform 122 relative to the frame 110, the first range of heights of the first portion of the surroundings associated with the sensor data generated by the first plurality of the range sensors 192 coupled to the forward platform 122 may move toward or away from the ground.

### Vehicle Control System

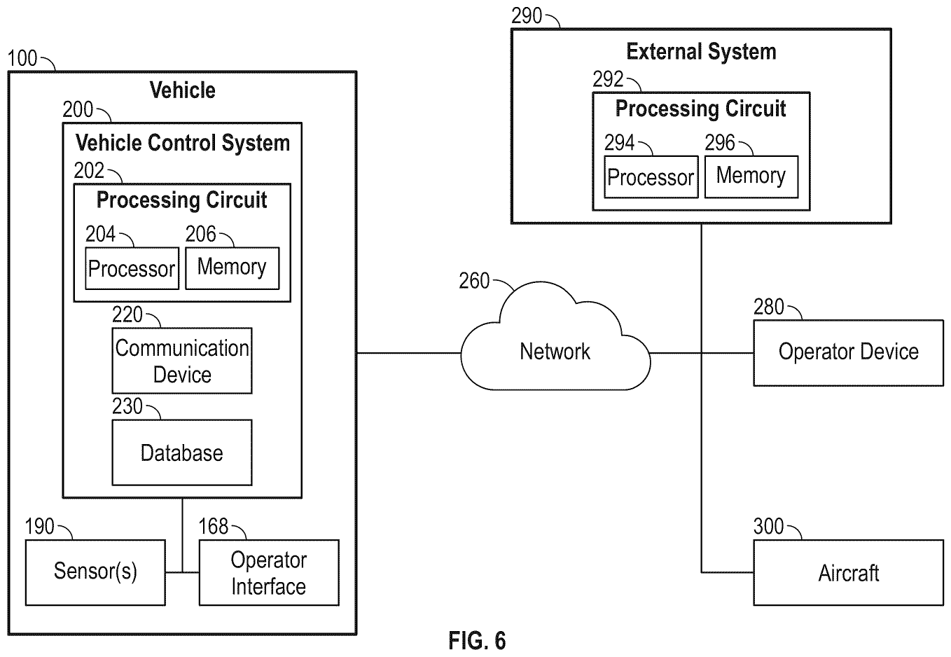

As shown in FIG. 6, the vehicle control system 200 includes a controller 202 that is positioned on the vehicle 100, an onboard communication device, shown as communication device 220, for transmitting and receiving data via a wireless connection, and at least one database, shown as database 230, configured to store data associated with the vehicle control system 200. The controller 202 includes a controller 202 that includes at least one processor, shown as processor 204, and one or more memory devices, shown as memory 206. The memory 206 may include one or more devices (e.g., RAM, ROM, Flash memory, hard disk storage) for storing data. The memory 206 may also store computer code and/or instructions for executing, completing and/or facilitating the various processes described herein. For example, the memory 206 may store instructions and the instructions may cause the processors 204 to perform functionality that generates recommended control inputs associated with the vehicle 100 based on sensor data received from the sensors 190. The memory 206 may include non-transient volatile memory, non-volatile memory, and non-transitory computer storage media. The memory 206 may include database components, object code components, script components, or any other type of information structure for supporting the various activities and information structures described herein. The memory 206 may communicably couple with the processor 204. The memory 206 may also be electrically coupled with the processor 204. The processor 204 may be implemented as one or more application specific integrated circuits (ASICs), one or more field programmable gate arrays (FPGAs), a group of processing components, and/or other suitable electronic processing components.

The communication device 220 may include network communication devices, network interfaces, and/or other possible communication interfaces. The communication device 220 facilitates wireless communication with various external devices and/or other vehicles 100. For example, the communication device 220 may transmit information associated with the sensor data received from the sensors 190 to a cloud computing server for further processing. The communication device 220 may include wired or wireless communications interfaces (e.g., jacks, antennas, transmitters, receivers, transceivers, wire terminals, etc.) for conducting data communications with sensors, devices, systems, etc., of the vehicle 100 and/or other external systems or devices (e.g., servers, operator devices, etc.). The communication device 220 may be direct (e.g., local wired or wireless communications) and/or via a communications network. For example, the communication device 220 may include an Ethernet card and port for sending and receiving data via an Ethernet-based communications link or network. The communication device 220 may also include a Wi-Fi and/or cellular transceiver for communicating via a wireless communications network. The communication device 220 may include a power line communications interface. The communication device 220 may include an Ethernet interface, a USB interface, a serial communications interface, and/or a parallel communications interface. Further, communication device 220 may facilitate transmissions between multiple response vehicles.

As shown in FIG. 6, the vehicle control system 200 may be configured to communicate with an external server, shown as external system 290 (e.g., an aircraft management system, an airport management system, etc.), configured to facilitate storing, analyzing, and/or distributing data associated with the vehicle control system 200; a device, shown as operator device 280, configured to facilitate communicating information to and/or from one or more operators of the vehicle 100; and/or an aircraft system, shown as aircraft 300, through the communication device 220 via a wireless network, shown as network 260. The network 260 may be and/or include a local area network (LAN), wide area network (WAN), telephone network (such as the Public Switched Telephone Network (PSTN)), Controller Area Network (CAN), wireless link, intranet, the Internet, a cellular network, and/or combinations thereof. The operator devices 280 may be and/or include at least one of a mobile computing device, a desktop computer, a smartphone, a tablet, a smart watch, a smart sensor and/or any other device that may facilitate providing, receiving, displaying and/or otherwise interacting with content (e.g., webpages, mobile applications, etc.).

An operator of the operator device 280 may perform various actions and/or access various types of information. The information may be provided over the network 260 (e.g., the Internet, LAN, WAN, cellular, etc.). Similarly, the operator device 280 may perform similar functionality to that of the operator controls 160. The operator device 280 may include an application to receive information, display information, and receive user interactions with the content. For example, the application may be a web browser and/or a mobile application. The operator of the operator device 280 may provide, via a user interface, data to the vehicle control system 200 and/or the external system 290.

The external system 290 may be and/or include at least one of a remote device, an external database, a computing device, and/or among other possible computer hardware and/or computer software that may interface with, via the network 260, at least one of the vehicle 100, and/or the operator device 280. By way of example, the external system 290 may be an aircraft control system of an airport (e.g., a site, etc.) configured to monitor information associated with aircraft located at the airport. The external system 290 includes at least one processing circuit, shown as processing circuit 292. The processing circuit 292 includes at least one processor, shown as processor 294, and memory, shown as memory 296. The processing circuit 292 and/or the components thereof (e.g., the processors 294 and the memory 296) may perform similar functionality to that of the vehicle control system 200 and/or a component thereof. By way of example, the external system 290 may receive data from the vehicle control system 200, the operator device 280, and/or the aircraft 300 via the network 260. The external system 290 may be configured to perform back-end processing of the data received from the vehicle control system 200, the operator device 280, and/or the aircraft 300. The external system 290 may be configured to transmit information, data, commands, recommended control inputs, and/or instructions to the vehicle 100.

The vehicle control system 200 is configured to determine a classification of the aircraft 300 associated with the operation of the vehicle 100. By way of example, the vehicle control system 200 may be configured to determine the classification of the aircraft 300 when the vehicle 100 approaches the aircraft 300 to unload cargo from and/or load cargo into the aircraft 300. In some embodiments, the vehicle control system 200 is configured to classify the aircraft 300 according to a make or model of the aircraft 300. By way of example, the vehicle control system 200 may determine to classify the aircraft 300 as a Boeing 737 based on the sensor data associated with the aircraft 300. In some embodiments, the vehicle control system 200 is configured to classify the aircraft 300 according to attributes of the aircraft 300. By way of example, the vehicle control system 200 may determine to classify the aircraft 300 according to a height of the aircraft 300, a width of the aircraft 300, a wingspan of the aircraft 300, a number of engines of the aircraft 300, a manufacturer of the aircraft 300, an operational type of the aircraft 300 (e.g., cargo, passenger, military, etc.), a year of manufacture of the aircraft 300, a payload capacity of the aircraft 300, a body configuration of the aircraft 300, and/or other attributes associated with the aircraft 300.

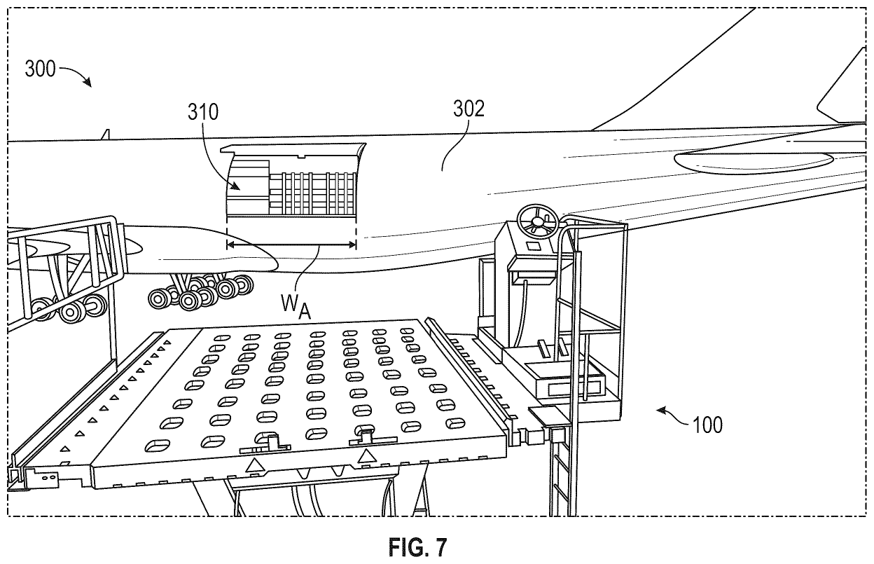

In some embodiments, the vehicle control system 200 determines the classification of the aircraft based on the sensor data received from the sensors 190. By way of example, the vehicle control system 200 may be configured to monitor the sensor data received from the sensors 190 for sensor data associated with the aircraft 300 and then utilize the sensor data associated with the aircraft 300 to determine the classification of the aircraft 300. In some embodiments, the vehicle control system 200 is configured to classify the aircraft 300 according to attributes of an opening, shown as cargo opening 310, defined in a body, shown as fuselage 302, of the aircraft 300 (as shown in FIG. 7). By way of example, the vehicle control system 200 may classify the aircraft 300 according to a height of the cargo opening 310, a width of the cargo opening 310, an angle of the cargo opening 310 relative to the fuselage 302 of the aircraft 300, and/or other attributes of the cargo opening 310 (e.g., operational attributes, geometrical attributes, etc.).

According to an exemplary embodiment, the vehicle control system 200 is configured to determine the classification of the aircraft 300 based on attributes of the cargo opening 310. In some embodiments, the vehicle control system 200 utilizes the sensor data received from the sensors 190 to determine the classification of the aircraft 300 based on the attributes of the cargo opening 310 of the aircraft 300. By way of example, the sensor data generated by the range sensors 192 may be utilized by the vehicle control system 200 to at least partially map out a profile of the fuselage 302 of the aircraft 300 based on distances between the range sensors 192 and portions of the fuselage 302 of the aircraft 300. The map of the profile of the fuselage 302 of the aircraft 300 may include an opening (e.g., a void, etc.) associated with the cargo opening 310 with a first portion of the fuselage 302 corresponding to a left side of the cargo opening 310 and a second portion of the fuselage 302 corresponding to a left side of the cargo opening 310. As shown in FIG. 7, the vehicle control system 200 may utilize the map of the profile of the fuselage 302 to determine a width W_{A} of the cargo opening 310 based on a distance between the first portion of the fuselage 302 and the second portion of the fuselage 302 (e.g., a distance across the cargo opening 310, etc.). By way of example, the vehicle control system 200 may utilize the map of the profile of the fuselage 302 to determine the width W_{A} of the cargo opening 310 by identifying a first straight line formed by the first portion of the fuselage 302, a second straight line formed by the second portion of the fuselage 302, and the void formed by the cargo opening 310 between the first portion of the fuselage 302 and the second portion of the fuselage 302. The vehicle control system 200 may utilize the width W_{A} of the cargo opening 310 to determine the classification of the aircraft 300. By way of example, the vehicle control system 200 may compare the width W_{A} of the cargo opening 310 with a set of widths of various cargo openings 310 of various aircraft 300 and the classifications associated with the various aircraft 300 stored in the database 230 to determine the classification of the aircraft 300.

In some embodiments, the vehicle control system 200 is configured to determine the classification of the aircraft 300 based on a profile of the fuselage 302 of the aircraft 300. The vehicle control system 200 may utilize the sensor data received from the sensors 190 to determine the classification of the aircraft 300 based on the profile of the fuselage 302 of the aircraft 300. By way of example, the sensor data generated by the range sensors 192 may be utilized by the vehicle control system 200 to at least partially map out a profile of the fuselage 302 of the aircraft 300 based on distances between the range sensors 192 and portions of the fuselage 302. The vehicle control system 200 may utilize the map of the profile of the fuselage 302 to determine the classification of the aircraft 300. By way of example, the vehicle control system 200 may compare the profile of the fuselage 302 of the aircraft 300 with profiles of various fuselages 302 of various aircraft 300 stored in the database 230 to determine the classification of the aircraft 300.

In some embodiments, the vehicle control system 200 is configured to determine the classification of the aircraft 300 based on attributes of the aircraft 300. The vehicle control system 200 may utilize the sensor data received from the sensors 190 to determine the classification of the aircraft 300 based on the attributes of the aircraft 300. By way of example, the sensor data generated by the range sensors 192 may be utilized by the vehicle control system 200 to at least partially map out a profile of the aircraft 300 based on distances between the range sensors 192 and portions of the aircraft 300. The map of the profile of the aircraft 300 may include various elements of the aircraft 300 such as wings, engines, landing gear, tail profiles, etc. The vehicle control system 200 may utilize the map of the profile of the aircraft 300 to determine various attributes of the aircraft 300. By way of example, the vehicle control system 200 may utilize the map of the profile of the aircraft 300 to determine a distance between front landing gear of the aircraft 300 and rear landing gear of the aircraft 300, a distance between wings of the aircraft 300 and a tail of the aircraft 300, a height of the fuselage 302 of the aircraft 300, a distance between the wings of the aircraft and the cargo opening 310 defined by the fuselage 302 of the aircraft 300, etc. The vehicle control system 200 may utilize the various attributes of the aircraft 300 to determine the classification of the aircraft 300. By way of example, the vehicle control system 200 may compare the distance between the front landing gear of the aircraft 300 and the rear landing gear of the aircraft 300 with a set of distances between front landing gear and rear landing gear of various aircraft 300 stored in the database 230 to determine the classification of the aircraft 300.

In some embodiments, the vehicle control system 200 is configured to determine the classification of the aircraft 300 based at least partially on data received from the operator device 280 (e.g., via the network 260, etc.). By way of example, the operator of the vehicle 100 may identify (e.g., manually identify, etc.) the aircraft 300 and operate the operator device 280 to provide data associated with the identification of the aircraft 300 to the vehicle control system 200 via the network 260. The vehicle control system 200 may utilize the identification of the aircraft 300 to determine the classification of the aircraft 300. As another example, the operator of the vehicle 100 may identify at least one attribute of the aircraft 300 and operate the operator device 280 to provide data associated with the at least one attribute of the aircraft 300 to the vehicle control system 200 via the network 260 (e.g., an airplane identification number, airline name, gate number, etc.). The vehicle control system 200 may utilize the at least one attribute of the aircraft 300 to determine the classification of the aircraft 300. By receiving the data from the operator device 280, an amount of computational power utilized by the controller 202 when determining the classification of the aircraft 300 may be reduced. By way of example, the data received from the operator device 280 may narrow down a number of potential classifications of the aircraft 300, allowing for the controller 202 to analyze fewer potential classifications of the aircraft 300 when determining the classification of the aircraft 300.

In some embodiments, the vehicle control system 200 is configured to determine the classification of the aircraft 300 based at least partially on data received from the external system 290 (e.g., via the network 260, etc.). By way of example, the vehicle 100 may be located at an airport and the external system 290 may include a list of various aircraft 300 located at the airport. The external system 290 may provide the list of the various aircraft 300 located at the airport to the vehicle control system 200 via the network 260 so that the vehicle control system 200 may determine that the aircraft 300 is one of the aircraft 300 on the list of the various aircraft 300 located at the airport. By receiving the data from the external system 290, an amount of computational power utilized by the controller 202 when determining the classification of the aircraft 300 may be reduced. By way of example, the data received from the external system 290 may narrow down a number of potential classifications of the aircraft 300, allowing for the controller 202 to analyze fewer potential classifications of the aircraft 300 when determining the classification of the aircraft 300.

In some embodiments, the vehicle control system 200 is configured to determine the classification of the aircraft 300 based at least partially on data received from the aircraft 300 (e.g., via the network 260, etc.). By way of example, when the vehicle 100 approaches the aircraft 300, the aircraft 300 may provide data associated with the aircraft 300 to the vehicle 100 via the network 260. The data provided by the aircraft 300 may include attributes associated with the aircraft 300 such as a manufacturer of the aircraft 300, a size of the aircraft 300, a model of the aircraft 300, etc. By receiving the data from the aircraft 300, an amount of computational power utilized by the controller 202 when determining the classification of the aircraft 300 may be reduced. By way of example, the data received from the aircraft 300 that includes the manufacturer of the aircraft 300 may narrow down a number of potential classifications of the aircraft 300 to classifications of aircrafts manufactured by the manufacturer, allowing for the controller 202 to analyze fewer potential classifications of the aircraft 300 when determining the classification of the aircraft 300.

In some embodiments, the vehicle control system 200 is configured to implement aircraft recognition techniques (e.g., a neural network, machine learning, artificial intelligence, etc.) to determine the classification of the aircraft 300. The aircraft recognition techniques may use predetermined aircraft profiles stored in the database 230 in order to determine the classification of the aircraft 300. The predetermined aircraft profiles stored in the database 230 may have already been associated with one of the aircrafts 300 and the classification of the one of the aircrafts 300 (e.g., manually associated, associated while training the aircraft recognition techniques, etc.). By way of example, the vehicle control system 200 may use the predetermined aircraft profiles stored in the database 230 to associate sensor data received from the range sensors 192 with one of the predetermined aircraft profiles stored in the database 230 to determine the classification of the aircraft 300. As another example, the vehicle control system 200 may use the predetermined aircraft profiles stored in the database 230 to associate image data received from the sensors 190 (e.g., cameras, etc.) with one of the predetermined aircraft profiles stored in the database 230 to determine the classification of the aircraft 300.

According to an exemplary embodiment, the vehicle control system 200 is configured to generate recommended controls (e.g., recommended control outputs, recommended control signals, etc.) for the vehicle 100 based on the classification of the aircraft 300. The recommended controls for the vehicle 100 may correspond to control outputs for operable components of the vehicle 100 (e.g., the forward platform assembly 120, the rearward platform assembly 150, the driveline 170, the braking system 180, steering controls, etc.) that cause the operable components of the vehicle 100 to operate. In some embodiments, the vehicle control system 200 is configured to generate the recommended controls for the vehicle 100 based on a location of the aircraft 300. The location of the aircraft 300 may be determined by the vehicle control system 200 based on the sensor data received from the sensors 190 and/or provided to the vehicle control system 200 by the operator device 280, the external system 290, and/or the aircraft 300. In some embodiments, the vehicle control system 200 is configured to autonomously or semi-autonomously control components of the vehicle 100 according to the recommended controls.

According to an exemplary embodiment, the vehicle control system 200 is configured to generate recommended controls associated with a width of the front end of the forward platform assembly 120 based on the classification of the aircraft 300. By way of example, based on the classification of the aircraft 300 corresponding with a first width W_{A} of the cargo opening 310, the vehicle control system 200 may generate recommended controls to operate the first flap 126, the second flap 128, and the third flap 130 to the raised positions (e.g., place the first flap 126, the second flap 128, and the third flap 130 in the raised position, etc.) such that the front end of the forward platform assembly 120 has the first width W₁ that corresponds with the first width W_{A} of the cargo opening 310. As another example, based on the classification of the aircraft 300 corresponding to a second width W_{A} of the cargo opening 310, the vehicle control system 200 may generate recommended controls to operate (i) the first flap 126 to the lowered position and (ii) the second flap 128 and the third flap 130 to the raised positions such that the front end of the forward platform assembly 120 has the second width W₂ that corresponds with the second width W_{A} of the cargo opening 310. As yet another example, based on the classification of the aircraft 300 corresponding to a third width W_{A} of the cargo opening 310, the vehicle control system 200 may generate recommended controls to operate (i) the first flap 126 and the second flap 128 to the lowered positions and (ii) the third flap 130 to the raised position such that the front end of the forward platform assembly 120 has the third width W₃ that corresponds with the third width W_{A} of the cargo opening 310. As another example, based on the classification of the aircraft 300 corresponding to a fourth width W_{A} of the cargo opening 310, the vehicle control system 200 may generate recommended controls to operate the first flap 126, the second flap 128, and the third flap 130 to the lowered positions such that the front end of the forward platform assembly 120 has the fourth width W₄ that corresponds with the fourth width W_{A} of the cargo opening 310.

In some embodiments, the vehicle control system 200 is configured to determine that the width W_{A} of the cargo opening 310 of the aircraft 300 is smaller than a minimum operating width of the vehicle 100 or larger than a maximum operating width of the vehicle 100. By way of example, if the width W_{A} of the cargo opening 310 of the aircraft 300 is smaller than the fourth width W₄, the vehicle 100 may not be able to interface with the aircraft 300 and vehicle control system 200 may not generate the recommended controls for the vehicle 100.

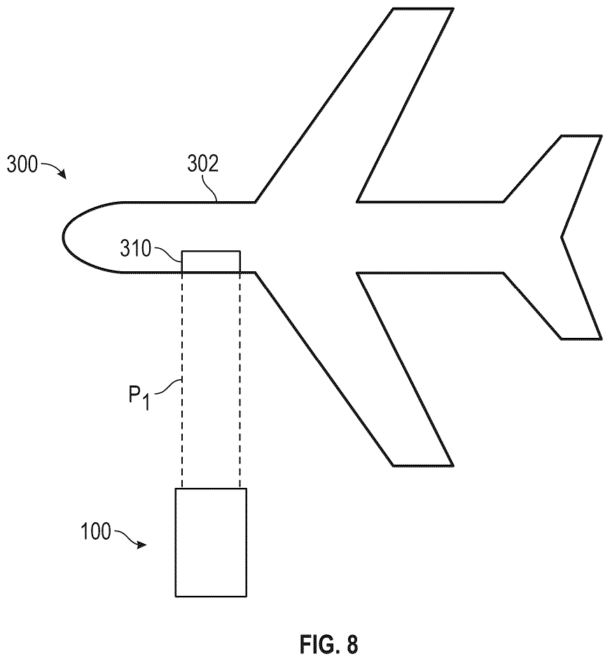

As shown in FIGS. 8-10, the vehicle control system 200 is configured to generate recommended controls associated with a recommended path of the vehicle 100 based on the classification of the aircraft 300. The recommended path of the vehicle 100 may be a path from a location for the vehicle 100 to follow while the vehicle 100 approaches the cargo opening 310 of the aircraft 300. In some embodiments, the vehicle control system 200 is configured to generate the recommended path of the vehicle 100 based on a first location of the aircraft 300 and a second location of the vehicle 100. By way of example, the recommended path may be a path from the second location of the vehicle 100 towards the first location of the aircraft 300. When the vehicle 100 follows the recommended path, the forward platform assembly 120 of the vehicle 100 may align with the cargo opening 310 of the aircraft 300 to allow for the vehicle 100 to unload cargo from and/or load cargo into the cargo opening 310 of the aircraft 300.

In some embodiments, the vehicle control system 200 is configured to determine that a recommended path of the vehicle 100 toward the cargo opening 310 is not possible based on the classification of the aircraft 300. By way of example, the classification of the aircraft 300 may correspond to the cargo opening 310 being positioned between one of the wings of the aircraft 300 and a tail wing of the aircraft 300. Based on a distance between the one of the wings and the tail wing of the aircraft 300 and a width or maneuverability of the vehicle 100, the vehicle control system 200 may determine that the vehicle 100 cannot fit or properly maneuver between the wing and the tail wing of the aircraft 300 without coming or potentially coming into contact with the wing or the tail wing of the aircraft 300. As a result, the vehicle control system 200 may determine that there is no recommended path for the vehicle 100 toward the cargo opening 310 and that the vehicle 100 should not approach the cargo opening 310.

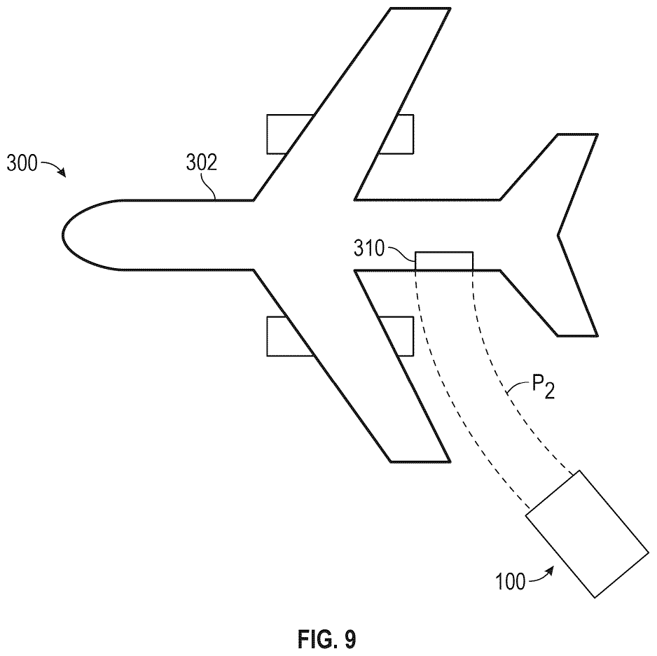

As shown in FIG. 8, the vehicle control system 200 may generate a first recommended path P₁ for the vehicle 100 based on the classification of the aircraft 300 corresponding to the cargo opening 310 being positioned forward of the wings of the aircraft 300. The first recommended path P₁ may be generally straight from the vehicle 100 towards the cargo opening 310 of the aircraft 300. As shown in FIG. 9, the vehicle control system 200 may generate a second recommended path P₂ for the vehicle 100 based on the classification of the aircraft 300 corresponding to the cargo opening 310 being positioned rearward of the wings of the aircraft 300. The second recommended path P₂ may be arc-shaped from a location rearward of the cargo opening 310 toward the cargo opening 310 to prevent contact between the vehicle 100 and the aircraft 300 when the vehicle 100 follows the second recommended path P₂. By way of example, the second recommended path P₂ may curve around a horizontal stabilizer of a tail of the aircraft 300 and inside of one of the wings of the aircraft 300 to avoid contact between the vehicle 100 and the horizontal stabilizer or the one of the wings. Additionally, the vehicle control system 200 may generate the second recommended path P₂ may avoid any engines coupled to the one of the wings of the aircraft 300 based on the classification of the aircraft 300 corresponding to a number of engines coupled to the wings of the aircraft 300. As a result, contact may be prevented between the vehicle 100 and the engines when the vehicle 100 follows the second recommended path P₂.

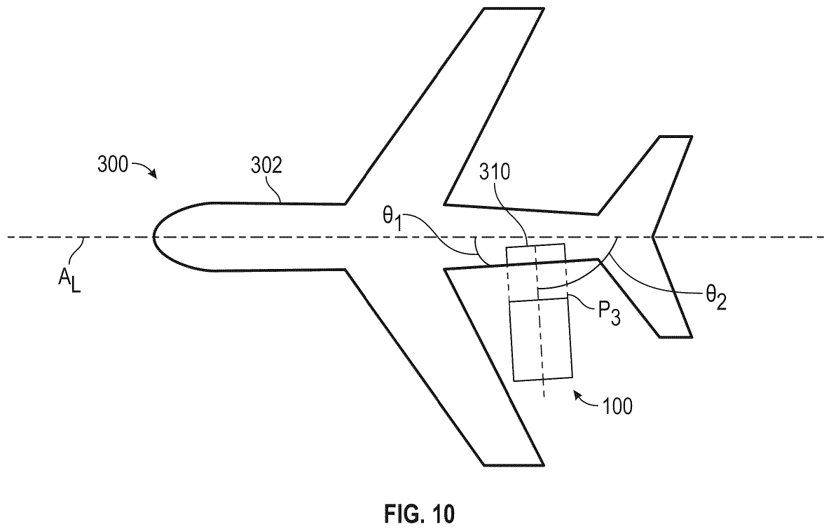

As shown in FIG. 10, the vehicle control system 200 may generate a third recommended path P₃ for the vehicle 100 based on the classification of the aircraft 300 corresponding to the cargo opening 310 being positioned on a portion of the fuselage 302 that is angled relative to a longitudinal axis of the aircraft 300, shown as longitudinal axis A_{L}, extending from a forward end of the aircraft 300 to a rearward end of the aircraft 300. The portion of the fuselage 302 that defines the cargo opening 310 is oriented at an angle θ₁ relative to the longitudinal axis A_{L}. Due to the orientation of the cargo opening 310 relative to the longitudinal axis A_{L}, an end portion of the third recommended path P₃ generated by the vehicle control system 200 may be oriented at an angle θ₂ relative to the longitudinal axis A_{L} to align the vehicle 100 with the cargo opening 310 at the end of the third recommended path P₃. By way of example, the end portion of the third recommended path P₃ may be non-perpendicular to the longitudinal axis A_{L} of the aircraft 300. In some embodiments, the end portion of the third recommended path P₃ may be perpendicular to the portion of the fuselage 302 that defines the cargo opening 310 (e.g., angle θ₁ and angle θ₂ are supplementary angles, etc.).

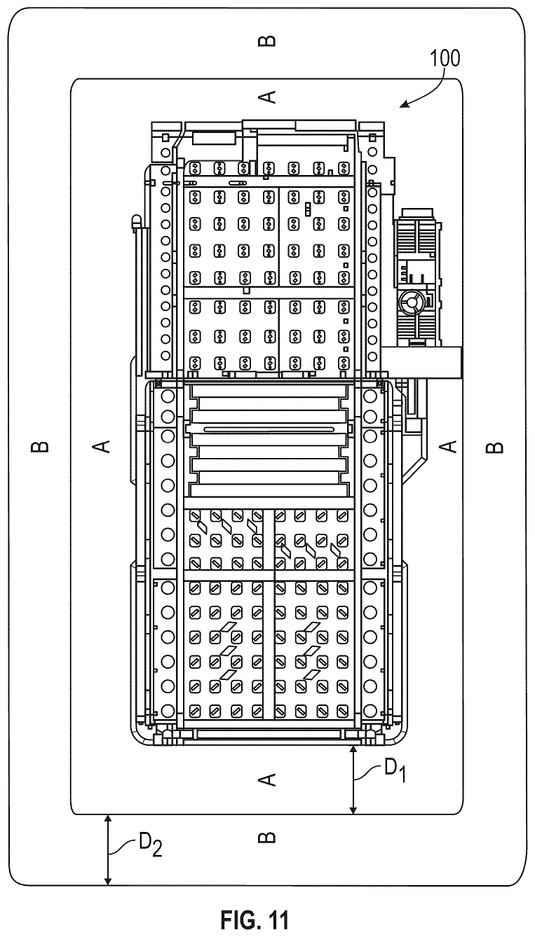

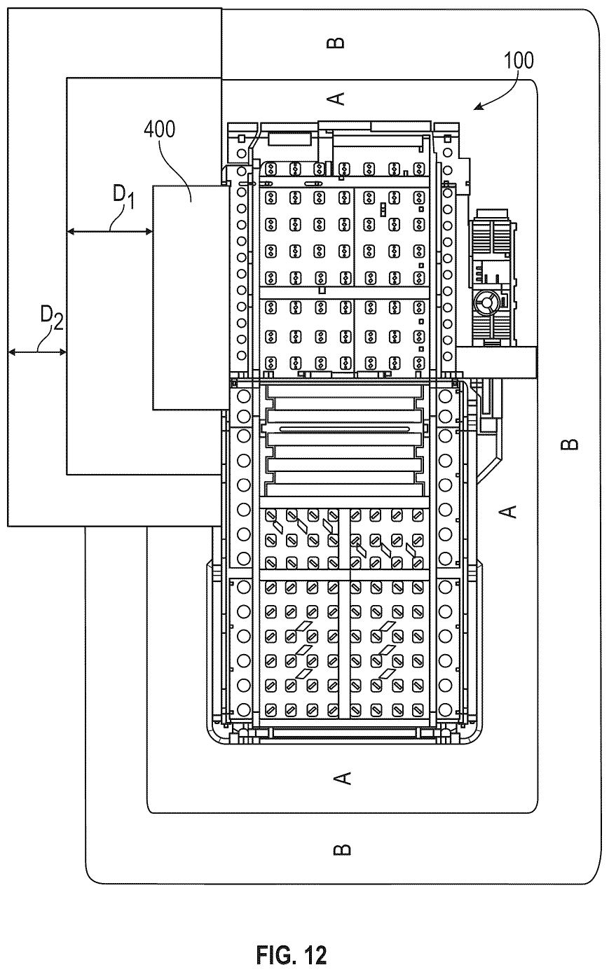

As shown in FIGS. 11 and 12, the vehicle control system 200 is configured to generate an object detection zone associated with the vehicle 100. The object detection zone includes a first zone A extending from the vehicle 100 a first distance D₁ and a second zone B extending from the first zone A second distance D₂. In some embodiments, the second zone B may be a warning zone and the first zone A may be a restricted zone. By way of example, when the vehicle control system 200 determines that an object is positioned in the second zone B (e.g., based on the sensor data generated by the sensors 190, etc.), the vehicle control system 200 may operate the operator interface 168 to provide a warning to the operator of the vehicle 100 that the object is positioned in the second zone B. When the vehicle control system 200 determines that an object is positioned in the first zone A (e.g., based on the sensor data generated by the sensors 190, etc.), the vehicle control system 200 may restrict and/or prevent the operation of components of the vehicle 100. For example, the vehicle control system 200 determines that the object is positioned in the first zone A, the vehicle control system 200 may prevent the operation of the driveline 170 to prevent the vehicle 100 from continuing to move towards and coming in contact with the object.

As shown in FIG. 12, the vehicle control system 200 is configured to modify the object detection zone associated with the vehicle 100 based on an attachment, shown as side attachment 400, coupled to the vehicle 100. The vehicle control system 200 may modify the object detection zone associated with the vehicle 100 such that the first zone A extends from the vehicle 100 and the side attachment 400 the first distance D₁ and the second zone B extends from the first zone A the second distance D₂. As a result, the operator may be warned and/or the operation of the vehicle 100 may be restricted when an object is in a proximity to the side attachment 400 to prevent contact between objects and the side attachment 400.

According to an exemplary embodiment, the vehicle control system 200 is configured to modify the object detection zone associated with the vehicle 100 based on the classification of the aircraft 300. By way of example, the vehicle control system 200 may modify the object detection zone such that the first distance D₁ associated with the first zone A and/or the second distance D₂ associated with the second zone B is smaller when the classification of the aircraft 300 corresponds to the cargo opening 310 being positioned rearward of the wings of the aircraft 300 than when the classification of the aircraft 300 corresponds to the cargo opening 310 being positioned forward of the wings of the aircraft 300. Since the vehicle 100 may be positioned closer to the wings of the aircraft 300 when approaching the cargo opening 310 positioned rearward of the wings of the aircraft 300 than when approaching the cargo opening 310 positioned forward of the wings of the aircraft 300, decreasing a size of the object detection zone when the cargo opening 310 is positioned rearward of the wings of the aircraft 300 may prevent the wings of the aircraft 300 from entering the first zone A or the second zone B as the vehicle 100 approaches the cargo opening 310.

In some embodiments, the vehicle control system 200 is configured to modify portions of the object detection zone associated with the vehicle 100 based on the classification of the aircraft 300. By way of example, the vehicle control system 200 may decrease a size of the object detection zone on the right side of the vehicle 100 when the classification of the aircraft 300 corresponds to the cargo opening 310 being positioned forward of the wings of the aircraft 300 to prevent the wing of the aircraft 300 positioned on the right side of the vehicle 100 from entering the object detection zone as the vehicle 100 approaches the cargo opening 310. As another example, the vehicle control system 200 may decrease a size of the object detection zone on the left side of the vehicle 100 when the classification of the aircraft 300 corresponds to the cargo opening 310 being positioned rearward of the wings of the aircraft 300 to prevent the wing of the aircraft 300 positioned on the left side of the vehicle 100 from entering the object detection zone as the vehicle 100 approaches the cargo opening 310.

In some embodiments, the vehicle control system 200 is configured to ignore objects positioned in the object detection zone based on the classification of the aircraft 300. By way of example, if the classification of the aircraft 300 indicates that a crew stairway of the aircraft 300 will be positioned proximate a cockpit of the aircraft 300, the vehicle control system 200 may ignore an indication that an object (e.g., an expected object, etc.) is present in the object detection zone at the position where the crew stairway of the aircraft 300 is expected to be positioned. As a result, the vehicle control system 200 may detect unexpected objects positioned in the object detection zone while ignoring expected objects associated with the aircraft 300 that are positioned in the object detection zone.

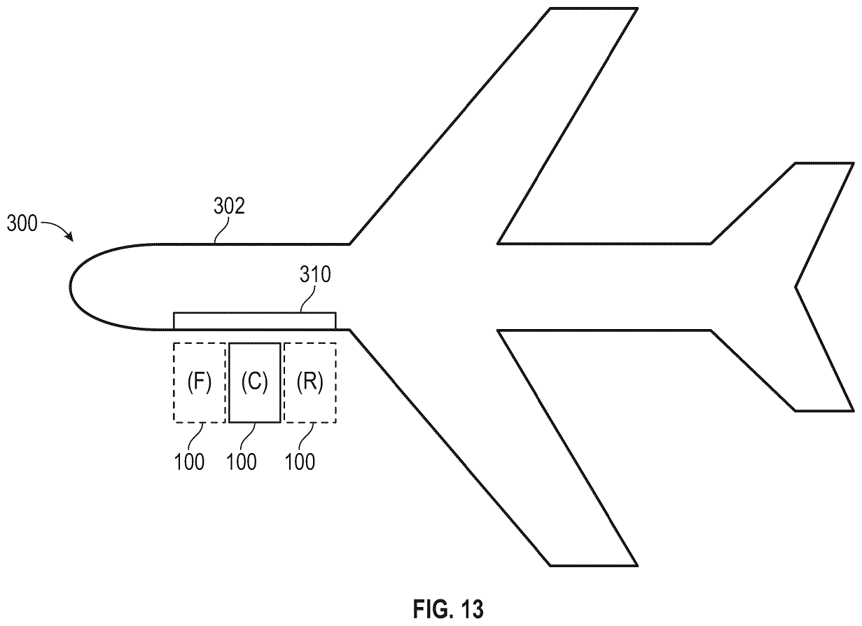

As shown in FIG. 13, the vehicle control system 200 is configured to generate recommended controls associated with an approach position of the vehicle 100 relative to the cargo opening 310 of the aircraft 300 based on the classification of the aircraft 300. By way of example, when the vehicle 100 is aligned with the cargo opening 310 of the aircraft 300, the vehicle 100 may be positioned in a center position C where the vehicle 100 is centered relative to the cargo opening 310, a forward position F where the vehicle 100 is positioned forward of the center position C, and a rearward position R where the vehicle 100 is positioned rearward of the center position C. It may be desirable to position the vehicle 100 in the forward position F, the center position C, or the rearward position R based on a configuration of the cargo opening 310 and/or a position of cargo within the cargo opening 310. However, if the classification of the aircraft 300 corresponds to a restriction associated with one of the forward position F, the center position C, or the rearward position R, the vehicle control system 200 may generate recommended controls associated with the unrestricted approach positions of the vehicle 100 relative to the cargo opening 310. By way of example, if the classification of the aircraft 300 corresponds to a restriction of the forward position F, the vehicle control system 200 may generate recommended controls associated with the center position C and the rearward position R without generating recommended controls associated with the forward position F. As another example, if the classification of the aircraft 300 corresponds to restrictions of the forward position F and the rearward position R, the vehicle control system 200 may generate recommended controls associated with the center position C without generating recommended controls associated with the forward position F or the rearward position R.

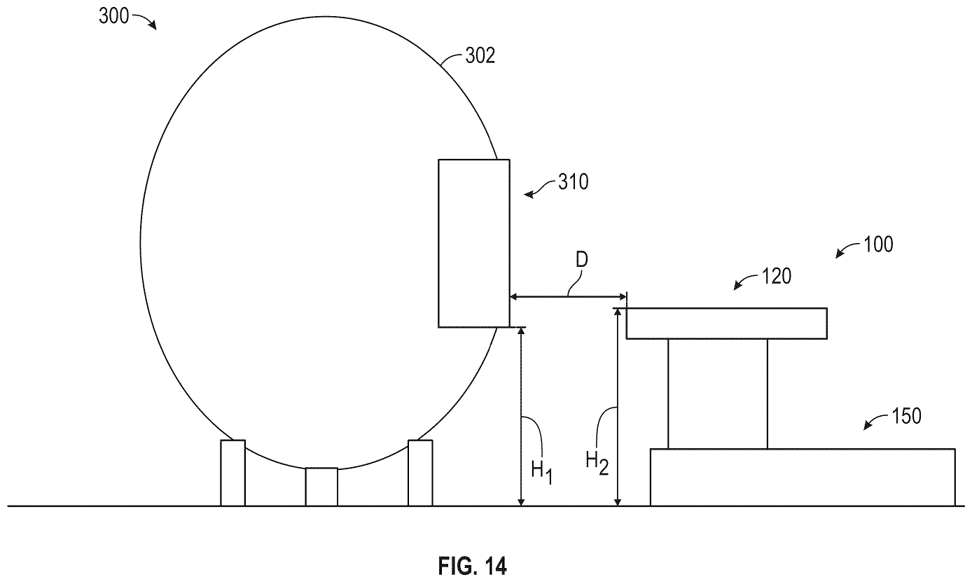

As shown in FIG. 14, the vehicle control system 200 is configured to generate recommended controls associated with a height of the forward platform assembly 120 based on the classification of the aircraft 300. By way of example, based on the classification of the aircraft 300 corresponding with a first height H₁ of a bottom of the cargo opening 310, the vehicle control system 200 may generate recommended controls to operate the forward scissor lift 124 of the forward platform assembly 120 to position the forward platform 122 at a second height H₂ such that cargo may be transferred between the cargo opening 310 and the forward platform 122. In some embodiments, the vehicle control system 200 may generate recommended controls to position the forward platform 122 at the second height H₂ that is equal to the first height H₁ of the bottom of the cargo opening 310 based on the classification of the aircraft 300. In some embodiments, the vehicle control system 200 may generate recommended controls to position the forward platform at the second height H₂ that is less than the first height H₁ of the bottom of the cargo opening 310 based on the classification of the aircraft 300. By way of example, the cargo opening 310 may include clamps configured to swing downward to engage the forward platform 122 to couple the vehicle 100 to the aircraft 300 when the forward platform 122 is positioned below the bottom surface of the cargo opening 310. In some embodiments, the vehicle control system 200 may generate recommended controls to position the forward platform at the second height H₂ that is greater than the first height H₁ of the bottom of the cargo opening 310 based on the classification of the aircraft 300.

As shown in FIG. 14, the vehicle control system 200 is configured to generate recommended controls associated with a distance D between the forward platform assembly 120 and the aircraft 300 based on the classification of the aircraft 300. By way of example, the vehicle control system 200 may generate first recommended controls to operate the driveline 170 to position the forward platform assembly 120 a first distance from the cargo opening 310 when the aircraft 300 has a first classification corresponding to the aircraft 300 including a gate that pivots downward to engage the forward platform assembly 120 and second recommended controls to operate the driveline 170 to position the forward platform assembly 120 a second distance from the cargo opening 310 that is less than the first distance when the aircraft 300 does not include a gate.

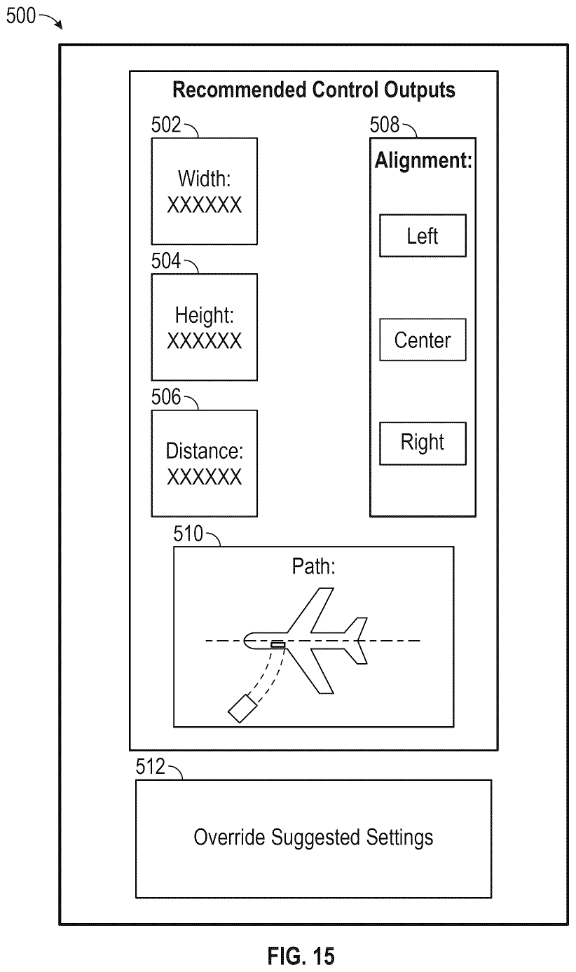

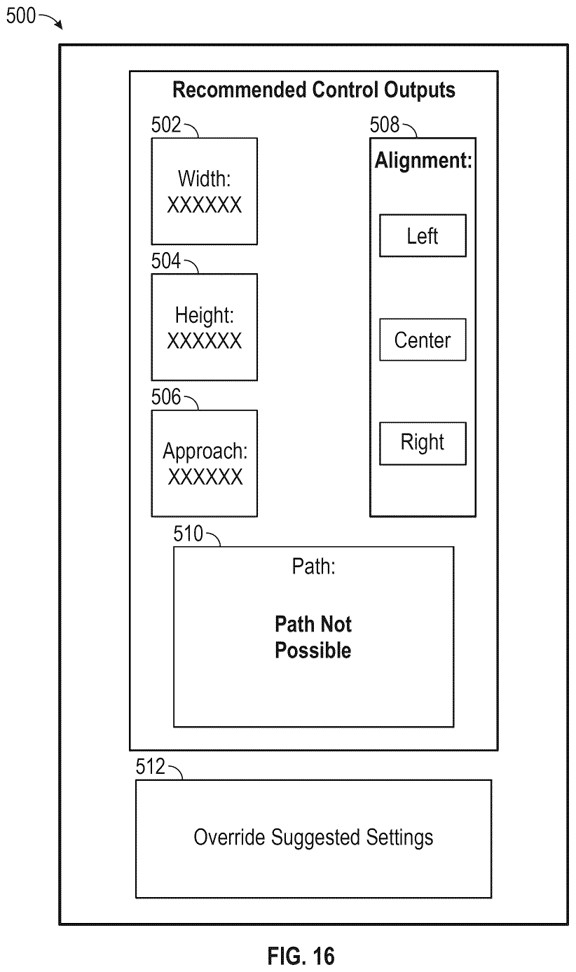

As shown in FIGS. 15 and 16, the vehicle control system 200 is configured to generate and provide a graphical user interface, shown as user interface 500, to the operator interface 168 of the operator controls 160 that corresponds to the recommended controls generated based on the classification of the aircraft 300. As shown in FIGS. 15 and 16, the user interface 500 includes a first element, shown as width element 502, associated with the recommended controls corresponding to the width of the front end of the forward platform assembly 120; a second element, shown as height element 504, associated with the recommended controls corresponding to the height of the forward platform 122 of the forward platform assembly 120; a third element, shown as distance element 506, associated with the recommended controls corresponding to the distance between the forward platform 122 of the forward platform assembly 120 and the cargo opening 310; a fourth element, shown as alignment element 508, associated with the recommended controls corresponds to the forward-rearward positioning of the vehicle 100 relative to the cargo opening 310; and a fifth element, shown as path element 510, associated with the control decisions corresponding to the recommended path of the vehicle 100 as the vehicle 100 moves toward the cargo opening 310.

In some embodiments, the width element 502 indicates instructions (e.g., image based instructions, text based instructions, indicator based instructions etc.) for the operator that, when followed by the operator, cause the first flap 126, the second flap 128, and/or the third flap 130 to be operated according to the recommended controls. By way of example, the width element 502 may include a first indicator light associated with the first flap 126, a second indicator light associated with the second flap 128, and a third indicator light associated with the third flap 130. When the first indicator light is red, the second indicator light is green, and the third indicator light is green, the width element 502 may indicate to the operator to operate the first flap 126 to the lowered position, the second flap 128 to the raised position, and the third flap 130 to the raised position.

In some embodiments, the height element 504 indicates instructions for the operator that, when followed by the operator, cause the forward scissor lift 124 to be operated to position the forward platform 122 according to the recommended controls. By way of example, the height element 504 may include a target height value indicative of a recommended height of the forward platform 122 and a current height value indicative of a current height of the forward platform 122 to allow for the operator to operate the as forward scissor lift 124 to move the forward platform 122 until the current height value equals the target height value.

In some embodiments, the distance element 506 indicates instructions for the operator that, when followed by the operator, cause the vehicle 100 to move to a location where the forward platform 122 is positioned a recommended distance away from the cargo opening 310 according to the recommended controls. By way of example, the distance element 506 may include an amount of time for the operator to press the accelerator 164 to move the vehicle 100 forward to the location where the forward platform 122 is positioned the recommended distance away from the cargo opening 310.

In some embodiments, the alignment element 508 indicates instructions for the operator that, when followed by the operator, cause the vehicle 100 to move into a recommended position of the forward position F, the center position C, or the rearward position R according to the recommended controls. By way of example, the alignment element 508 may include icons associated with each of the forward position F, the center position C, and the rearward position R and the icon associated with the recommended position may be illuminated to indicate which of the forward position F, the center position C, or the rearward position R is the recommended position.

As shown in FIG. 15, the path element 510 indicates instructions for the operator that, when followed by the operator, cause the vehicle 100 to move along the recommended path towards the cargo opening 310 according to the recommended controls. By way of example, the path element 510 may include a map that indicates a position of the vehicle 100 relative to the cargo opening 310 and the recommended path for the vehicle 100 to follow. As shown in FIG. 16, the path element 510 indicates that a path of the vehicle 100 towards the cargo opening 310 is not possible when the vehicle control system 200 determines that there is not a recommended path for the vehicle 100. The path element 510 may notify the operator of the vehicle 100 that a different vehicle may be needed to load cargo into and/or unload cargo from the cargo opening 310 of the aircraft 300 when there is not a recommended path for the vehicle 100.

According to the exemplary embodiment shown in FIGS. 15 and 16, the user interface 500 includes an actionable element (e.g., a button, etc.), shown as override button 512, associated with overriding the recommended controls of the vehicle 100. The operator of the vehicle 100 may select the override button 512 to override the recommended controls generated by the vehicle control system 200 based on the classification of the aircraft 300. For example, if the recommended controls include operating the first flap 126, the second flap 128, and the third flap 130 to the raised position, the operator may select the override button 512 to override the recommended controls and operate (i) the first flap 126 to the lowered position and (ii) the second flap 128 and the third flap 130 to the raised position. In some embodiments, the vehicle control system 200 may record when the operator selects the override button 512 and store the selection of the override button 512 and a corresponding time frame in the database 230. As a result, if an incident (e.g., an accident, a collision, etc.) occurs during the operation of the vehicle 100, a person may determine if the operator of the vehicle 100 was following the recommended controls of the vehicle 100 or if the operator selected the override button 512 and was not following the recommended controls of the vehicle 100. In other embodiments, the user interface 500 does not include the override button 512 and the vehicle control system 200 is configured to automatically record when the operator of the vehicle 100 does not follow the recommended controls.

### Process for Providing Recommended Controls

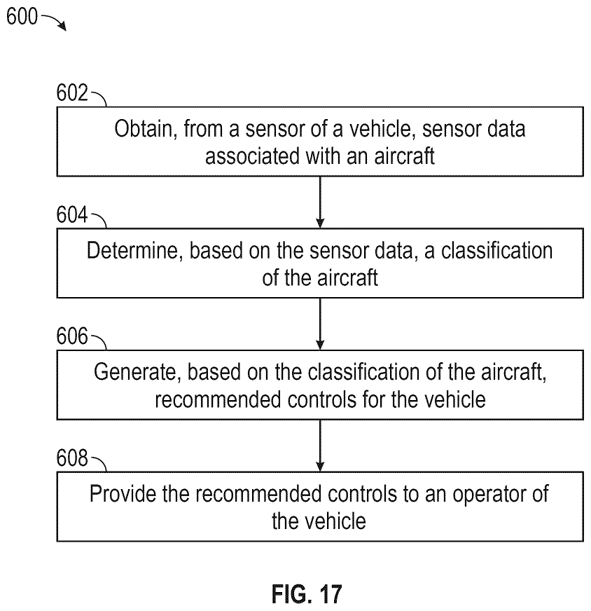

Referring now to FIG. 17, a flow chart of a process 600 for providing recommended controls to an operator of a vehicle configured to interface with an aircraft is shown, according to an exemplary embodiment. The process 600 may be executed by, for example, the vehicle control system 200. Further, any computing device described herein can be configured to perform at least a portion of the process 600 (e.g., the vehicle control system 200, the operator device 280, the external system 290, etc.).

In some embodiments, the process 600 begins in response to receiving sensor data from a sensor of a vehicle configured to interface with an aircraft. By way of example, as the vehicle 100 approaches the aircraft 300, the range sensors 192 may generate sensor data associated with the aircraft 300 and provide the sensor data to the vehicle control system 200. In some embodiments, the process 600 begins in response to receiving a user input from an operator of a vehicle. By way of example, an operator of the vehicle 100 may interface with a portion of the operator controls 160 associated with identifying aircraft and the operator controls 160 may generate a user input associated with identifying aircraft and provide the user input to the vehicle control system 200 to begin the process 600. In some embodiments, the process 600 begins in response to a vehicle being assigned to an aircraft. By way of example, the external system 290 may assign the vehicle 100 to unload the aircraft 300 and the process 600 may begin after the vehicle control system 200 has received the assignment from the external system 290 via the network 260.

As shown in FIG. 17, the process 600 includes obtaining, from a sensor of a vehicle, sensor data associated with an aircraft (step 602), according to some embodiments. The sensor data may include image data that includes an image associated with the aircraft and/or range data that includes a range of distances from the sensor to portions of the aircraft. In some embodiments, the vehicle control system 200 may obtain the sensor data associated with the aircraft 300 from the sensors 190 of the vehicle 100. By way of example, the range sensors 192 of the vehicle 100 may generate range data associated with various distances between the range sensors 192 and portions of the aircraft 300 and may provide the range data to the vehicle control system 200. In some embodiments, the vehicle control system 200 may receive additional data associated with the aircraft 300 from at least one of the operator device 280, the external system 290, or the aircraft 300. By way of example, the vehicle control system 200 may receive data associated with attributes of the aircraft 300 that were manually identified by an operator from the operator device 280 based on user inputs from the operator. As another example, the vehicle control system 200 may receive data associated with a list of the aircrafts 300 located in a portion of an airport where the vehicle 100.

As shown in FIG. 17, the process 600 further includes determining a classification of the aircraft based on the sensor data (step 604), according to some embodiments. The classification of the aircraft may correspond to various attributes of the aircraft. By way of example, the classification of the aircraft may correspond to at least one of a make of the aircraft, a model of the aircraft, a position of a cargo door relative to a fuselage of the aircraft, a height of the cargo door of the aircraft, a width of the cargo door of the aircraft, a number of engines of the aircraft, or a cargo capacity of the aircraft. In some embodiments, step 604 may be performed by the vehicle control system 200 based on the sensor data received from the sensors 190 of the vehicle 100. By way of example, the vehicle control system 200 may determine the classification of the aircraft 300 by generating a profile of the cargo opening 310 of the aircraft 300 using the sensor data received from the range sensors 192 and comparing the profile of the cargo opening 310 to profiles of various cargo openings stored in the database 230. As another example, the vehicle control system 200 is configured to determine the classification of the aircraft 300 by associating the sensor data received from the sensors 190 with predetermined aircraft profiles stored in the database 230.

As shown in FIG. 17, the process 600 further includes generating recommended controls for the vehicle based on the classification of the aircraft (step 606), according to some embodiments. The recommended controls are associated with control outputs for components of the vehicle that would result in recommended operation of the components of the vehicle based on the classification of the aircraft. By way of example, if the classification of the aircraft is associated with a loading door of the aircraft being position on a forward section of the aircraft, the recommended controls may be associated with control outputs that would result in the vehicle being driving toward the forward section of the aircraft to interface with the loading door. As another example, if the classification of the aircraft is associated with the loading door of the aircraft being positioned a first height off of the ground, the recommended controls may be associated with control outputs that would result in a loading platform of the vehicle being lifted to the first height off of the ground to align with the loading door of the aircraft. In some embodiments, the recommended controls are associated with control inputs for an operator of the vehicle that would result in the recommended operation of the vehicle. By way of example, the recommended controls may be associated with the operator holding down a button for a certain amount of time in order to operate a lift of the vehicle to lift a platform to a desired height. In some embodiments, the recommended controls may be generated by the vehicle control system 200 and may be recommended controls for the components of the vehicle 100.

As shown in FIG. 17, the process 600 further includes providing the recommended controls to an operator of the vehicle (step 608), according to some embodiments. By way of example, the recommended controls may be provided to the operator of the vehicle via an operator interface (e.g., a display, a control panel, etc.) such that the operator of the vehicle may operate the vehicle according to the recommended controls. By way of example, the recommended controls may include a recommended path for the vehicle to follow while approaching the aircraft and the recommended path may be provided to the operator of the vehicle such that the operator may operate the vehicle to follow the recommended path while approaching the aircraft. In some embodiments, the vehicle control system 200 operates the operator interface 168 to provide the recommended controls to the operator of the vehicle 100 via the operator interface 168.

In some embodiments, the process 600 includes operating the vehicle autonomously or semi-autonomously based on the recommended controls. By way of example, once the recommended controls have been generated, the components of the vehicle may be autonomously operated according to the recommended controls. As another example, once the recommended controls have been provided to the operator of the vehicle, the operator authorize for the components of the vehicle to be autonomously operated according to the recommended controls.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 100 and the systems and components thereof (e.g., frame 110, forward platform assembly 120, rearward platform assembly 150, operator controls 160, driveline 170, braking system 180, the vehicle control system 200, etc.) as shown in the various exemplary embodiments is illustrative only. Additionally, any element disclosed in one embodiment may be incorporated or utilized with any other embodiment disclosed herein.

1. A system comprising:
a vehicle configured to interface with an aircraft, the vehicle including:
a chassis;
a plurality of tractive elements coupled to the chassis;
a prime mover configured to drive at least one of the plurality of tractive elements to propel the vehicle; and
one or more sensors configured to generate sensor data corresponding to the aircraft; and
one or more processing circuits configured to:
acquire, from the one or more sensors, the sensor data;
determine, based on the sensor data, a classification of the aircraft;
generate, based on the classification of the aircraft, recommended controls for the vehicle; and
provide the recommended controls to an operator of the vehicle.

2. The system of claim 1, wherein:
the vehicle includes:
a platform assembly configured to interface with the aircraft to receive cargo; and
a lift coupled between the chassis and the platform assembly, the lift configured to raise and lower the platform assembly relative to the chassis; and
the recommended controls include operating the lift to position the platform assembly at a height relative to the chassis.

3. The system of claim 2, wherein at least one of the one or more sensors is coupled to the lift such that the lift is configured to raise and lower the at least one of the one or more sensors relative to the chassis.

4. The system of claim 1, wherein:
the vehicle includes a platform assembly coupled to the chassis, the platform assembly configured to interface with the aircraft to receive cargo, the platform assembly including:
a platform; and
a flap pivotably coupled to the platform, the flap pivotable between a raised position and a lowered position, wherein a forward end of the platform has a first width when the flap is in the raised position and a second width when the flap is in the lowered position, the first width greater than the second width; and
the recommended controls include placing the flap in the raised position or the lowered position.

5. The system of claim 1, wherein the recommended controls include operating the prime mover to propel the vehicle along a path toward the aircraft.

6. The system of claim 5, wherein the path is a recommended path from a current location of the vehicle to a location where the vehicle interfaces with the aircraft.

7. The system of claim 6, wherein the recommended path approaches at an angle of approach relative to a longitudinal axis of the aircraft that corresponds to the classification of the aircraft.

8. The system of claim 1, wherein the one or more processing circuits are configured to determine the classification of the aircraft based on a portion of the sensor data corresponding to a cargo opening of the aircraft.

9. The system of claim 1, wherein:
the one or more processing circuits are configured to acquire, from an aircraft management system associated with a site, monitoring data corresponding to the aircraft positioned at the site; and
the one or more processing circuits determine the classification of the aircraft based on the monitoring data.

10. The system of claim 1, wherein the one or more processing circuits are configured to:
generate an object detection zone associated with the vehicle; and
responsive to determining, based on the sensor data, that an object is positioned within the object detection zone, limit operation of the vehicle.

11. The system of claim 10, wherein a size of the object detection zone corresponds to the classification of the aircraft.

12. The system of claim 10, wherein, responsive to determining, based on the classification of the aircraft, that the object is an expected object associated with the aircraft, allow operation of the vehicle.

13. The system of claim 1, wherein the one or more processing circuits are configured to operate the vehicle according to the recommended controls.

14. A cargo loader vehicle configured to interface with an aircraft, the cargo loader vehicle comprising:
a chassis;
a plurality of tractive elements coupled to the chassis;
a prime mover configured to drive at least one of the plurality of tractive elements to propel the cargo loader vehicle;
a platform assembly configured to interface with the aircraft to receive cargo, the platform assembly including:
a platform; and
a flap pivotably coupled to the platform, the flap pivotable between a raised position and a lowered position, wherein a forward end of the platform has a first width when the flap is in the raised position and a second width when the flap is in the lowered position, the first width greater than the second width;
a lift coupled between the chassis and the platform assembly, the lift configured to raise and lower the platform assembly relative to the chassis; and
one or more processing circuits configured to:
acquire aircraft data corresponding to the aircraft;
determine, based on the aircraft data, a classification of the aircraft;
generate, based on the classification of the aircraft, recommended controls for the cargo loader vehicle, the recommended controls including at least one of operating the lift to position the platform assembly at a height relative to the chassis, placing the flap in the raised position or the lowered position, or operating the prime mover to propel the cargo loader vehicle along a path toward the aircraft; and
provide the recommended controls to an operator of the cargo loader vehicle.

15. The cargo loader vehicle of claim 14, wherein the one or more processing circuits are configured to acquire a portion of the aircraft data from an aircraft monitoring system associated with a site, the portion of the aircraft data corresponding to the aircraft positioned at the site.

16. The cargo loader vehicle of claim 14, further comprising one or more sensors configured to generate a portion of the aircraft data.

17. The cargo loader vehicle of claim 14, wherein the one or more processing circuits are configured to:
generate an object detection zone associated with the cargo loader vehicle; and
responsive to determining that an object is positioned within the object detection zone, limit operation of at least one of the prime mover, the lift, or the flap.

18. The cargo loader vehicle of claim 17, wherein, responsive to determining, based on the classification of the aircraft, that the object is an expected object associated with the aircraft, allow operation of the cargo loader vehicle.

19. A method for providing recommended controls to an operator of a vehicle, the method comprising:
acquiring, from one or more sensors of the vehicle, sensor data corresponding to an aircraft;
determining, based on the sensor data, a classification of the aircraft;
generating, based on the classification of the aircraft, recommended controls for the vehicle; and
providing the recommended controls to an operator of the vehicle.

20. The method of claim 19, wherein the recommended controls include at least one of adjusting a height of a platform of the vehicle, adjusting a width of the platform of the vehicle, or propelling the vehicle along a path toward the aircraft.
